(19) United States
(12) Patent Application Publication
(10) Pub. No.: US 2013/0157718 A1
(43) Pub. Date: Jun. 20, 2013

(54) SITUATIONALLY AWARE PORTABLE ELECTRONIC DEVICE

(71) Applicants: James A. Johanson, III, Schwenksville, PA (US); Manish A. Singh, Breinigsville, PA (US)

(72) Inventors: James A. Johanson, III, Schwenksville, PA (US); Manish A. Singh, Breinigsville, PA (US)

(73) Assignee: Intel Mobile Communications GmbH, Neubiberg (DE)

(21) Appl. No.: 13/326,431

(22) Filed: Dec. 15, 2011

(51) Int. Cl. H04W 88/02

(52) U.S. Cl. 455/556.1

(57) ABSTRACT

A portable electronic device, a method and a non-transitory computer-readable media are provided for enabling a device to determine if it is lost or stolen. The device includes a processing unit and a memory, at least two sensors connected to the processing unit, a data acquisition module for polling at least one of the sensors and storing the related information that it polls in the memory, a pattern-seeking module for processing the information to determine a threshold, and a comparator for comparing the information to the threshold. When the device has reached the threshold, it changes to an active state where it can do various tasks.

### TECHNICAL FIELD

Various aspects of this disclosure relate generally to a data acquisition system for a mobile device. More particularly, a system for acquiring and analyzing changes in data related to the mobile device.

### BACKGROUND

Situational awareness has been defined as the perception of elements in the environment within a volume of time and space, the comprehension of their meaning, and the projection of their status in the near future. While generally regarded as a cognitive process, computer implementation of algorithms providing a limited degree of automated situational awareness already have a place among consumer products. Early examples of such fully automated systems include the Roomba available from the iRobot Corp. of Bedford, Mass. (Roomba is a registered trademark of the iRobot Corp.). The Roomba cleaning robot includes an array of dedicated sensors to directly perceive the parameters of an environment, such as a residential floor plan, which are initially unknown to the system and are subject to change. Such devices can carry out specific tasks, track their own progress and make decisions including when to perform rudimentary maintenance, charge themselves, or to solicit help by alerting a human operator.

Modem mobile devices including cellular telephones, so-called smartphones, tablet and laptop computers, PDA's and the like in addition to native computing and wireless communication capability typically have a wide array of sensory capability owing to hardware including charge-coupled device (CCD) cameras, microphones, touch and tilt sensors, each of which are present to support specific features of the mobile device, and are otherwise dormant Typical mobile devices also have one or more input devices such as a keyboard, which may be a physical keyboard or displayed virtually such as on a touchscreen. Additional input may be provided through one or more input ports such as a universal serial bus (USB) or a flash memory port. Output interface with a user of a mobile device, conversely, takes place for example through speakers or a display screen.

When a mobile device has been lost or stolen, the authorized user can use a service such as MobileMe available from Apple Inc. of Cupertino, Calif. (MobileMe is a registered trademark of Apple Inc.). MobileMe is a subscription based service that allows the authorized user of the phone to track its whereabouts by access to available network information and optionally to remotely erase its contents. In addition, some mobile devices can be selectively secured by a code, or password, restricting access to some or all of the mobile device's features to the authorized users in possession of the password.

Finally, most carriers allow the account which the device uses for voice and/or data to be closed as soon as the authorized user registers a phone as being stolen, thereby mitigating some losses attributable to the theft of the device.

### SUMMARY OF THE INVENTION

Various aspects of this disclosure provide a portable electronic device including: a processing unit having a memory. A plurality of sensors is connected to the processing unit, which collect data. A data acquisition module for polling at least one of said sensors and storing related information thereto in memory is also provided for. The information from the data acquisition module is then passed into a pattern-seeking module for processing, whereupon the pattern-seeking module determines a threshold. The device also includes a comparator for comparing the information from the pattern seeking module to the threshold. Finally, when the threshold has been reached, the device then changes to an active state.

Another aspect of the disclosure concerns a method for determining if a portable electronic device is lost or stolen. The first step of the method is polling information from a plurality of sensors to gather data and then storing the information in a memory. In the second step, processing of the information occurs to determine a threshold. Subsequently, the current information is then compared to the threshold, wherein upon reaching the threshold, the device changes to an active state.

Finally, a non-transitory computer-readable media for carrying out a method for determining if a portable electronic device is lost or stolen is claimed. The method includes polling information from at least one of a plurality of sensors. In the second step, processing of the information occurs to determine a threshold. Subsequently, the current information is then compared to the threshold, wherein upon reaching the threshold, the device changes to an active state.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the subject matter disclosed herein. In the following description, various aspects of this disclosure are described with reference to the following drawings, in which:

FIG. 1 shows a mobile phone according to an aspect of this disclosure;

FIG. 2 shows a block diagram according to an aspect of this disclosure;

FIG. 3 shows a block diagram according to another aspect of this disclosure;

### DESCRIPTION

The following detailed description refers to the accompanying drawings that show, by way of illustration, specific details and aspects of this disclosure in which the subject matter disclosed herein may be practiced.

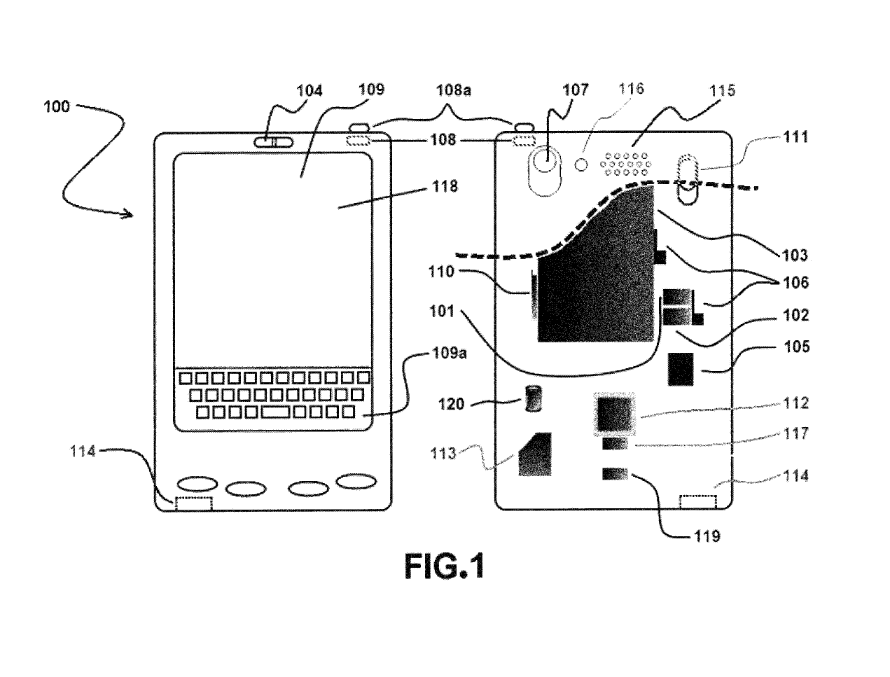

The word “exemplary” is used herein to mean “serving as an example, instance, or illustration.” Any aspect of this disclosure or design described herein as “exemplary” is not necessarily to be construed as preferred or advantageous over other aspects of this disclosure or designs. A mobile electronic device in accordance with the present subject matter is shown in schematic form in FIG. 1. Mobile device 100, in this case a cellular telephone having substantial independent computing capability in addition to its function as a telephone (i.e. a smartphone) is shown from both the front and backside, with a portion of the back cover cut away to show exemplary components. Although FIG. 1 discloses a smartphone, any mobile device is contemplated for use in connection with the disclosed exemplary aspects of this disclosure. As shown, mobile device 100, in common with a typical smartphone is based upon a central processing unit (CPU) 101 with memory 102 powered by rechargeable battery 103 when not connected to a stationary power source such as a charger (not shown). The CPU 101 interfaces with a plurality of input/output devices including microphone 104 and speaker 115, touchscreen 109 and keyboard 109a. Also commonly, CCD-based camera 107 is provided. When in use, microphone 104 and speaker 115 provide basic two-way voice telephone functions, in addition to recording and playback of audio stored, for example in memory 102. Likewise touchscreen 109 provides visual display output, as well as tactile input such as in connection with a graphical user interface (GUI). Keyboard 109a may be a physical keyboard or may be a virtual representation of a keyboard displayed on touchscreen 109 for purposes of alphanumeric data entry. Camera 107 can be used selectively to record still or moving images, or to provide light-level information to CPU 101 such as for purposes of dimming the display on touchscreen 109.

Also connected to CPU 101, RF module 108 includes antennae 108a enabling bidirectional remote communication between mobile device 100 and a network (not shown). RF module 108 may be configured to transmit and receive data according to standards including but not limited to Wi-Fi, WiMax, Bluetooth, mobile broadband 2G/3G/LTE, etc.

Specialized input to CPU 101 of mobile device 100 may be provided directly by a wide range of sensors, including tilt sensors 105 and accelerometers 120, GPS receivers 111, internal temperature monitors 106 and battery voltage sensor 110. Typically, mobile device 100 relies upon input from these sensors for orienting the display or the mobile device itself 100, localizing the device, monitoring internal component temperatures or battery charge levels. Less typically, FIG. 1 also illustrates 3-axis gyroscope 112 used for optical image stabilization (OIS) or for dead reckoning when mobile device 100 is used for in-vehicle navigation. Similarly, existing technology could provide input from solid-state barometric or hygrometric sensors.

Foreseeable capabilities of future mobile devices might include biometric or physiometric sensing such as pulse rate, DNA, palm print, iris recognition, etc. Sensors may also conceivably be found external to mobile device 100, located for example within smart garments and wirelessly transmitted to CPU 101.

Mobile device 100 also typically provides access to CPU 101 through data ports and interfaces such as Subscriber Identity Module (SIM) card port 113 and universal serial bus (USB) port 114. These ports are configured to permit selective attachment of external data sources such as a SIM card or a USB device (i.e. a flash drive, keyboard, pointing device, printer, portable media player, network adapter, etc.).

Mobile device 100 further comprises specialized output components. These are illustrated at least in part in FIG. 1. Speaker 115, discussed above, is used for sound output of the device, for example. Also illustrated is camera flash 116, which is used for illumination in connection with camera 107. Display LEDs 118 and vibration generators 117 are also output devices in this sense.

These components are not limited to mobile phones. On the contrary, many of these components can be built into or attached to other portable electronic devices such as laptops, camcorders, cameras, etc.

The above-mentioned components and devices are generally connected to and controlled by CPU 101 and operate in accordance with the internal requirements of the device, or selectively by the user.

As described above, each of tilt sensor 105, accelerometer 120, GPS receiver 111, internal temperature monitor 106 and battery voltage sensor 110, provide data input to CPU 101, as these sensors are designed to monitor specific environmental or component-specific conditions and provide data directly related thereto. A barometer or hygrometer to the extent implemented in mobile device 100 would similarly provide data of this type, each reporting directly on the environmental condition to which it is sensitive.

Other types of input devices connected to CPU 101 such as touchscreen 109, and/or keyboard 109a are not intended to report directly on specific environmental parameters in the manner of a sensor, although data from these components, when aggregated and analyzed, may provide some relevant information about the user, or the environment of mobile device 100 by inference. Examples of information that may be inferred from the input of a touchscreen could be the size of a user's hand, style of screen input, or even information related to the user's fingerprint. Failure to enter a correct password on a keyboard also provides sub-textual or inferred information. Similarly, input to CPU 101 by RF module 108 can reveal information about the ambient radio frequency landscape that could provide clues as to the location or movement of mobile device 100.

Camera 107 or microphone 115 are examples of sensors that can provide gross sound or light level sensing, or with aggregation and analysis of sensor output might provide detailed voice or image data. Depending on the resolution of data from one or more of the other input devices of mobile device 100, inputs may also be combinable to provide nuanced perceptual information.

To the extent that mobile device 100 has been described with regard to FIG. 1 above as a conventional mobile device, such as a smartphone, its appearance and primary function as a mobile device in the exemplary aspect of this disclosure is advantageously essentially indistinguishable from a conventional mobile device. In this way, as described in detail below, exemplary aspects of the present disclosure may overlay the topology of a common smartphone, tablet, or other mobile device. Indeed, the exemplary aspects of this disclosure may be incorporated into existing mobile devices, or a mobile device can be designed around one or more aspects disclosed herein.

During normal operation of a conventional mobile device, a large fraction of the native sensory capabilities may be dormant at any particular point in time. Polling of light level in connection with screen brightness, or monitoring of internal component temperature or battery charge level may only occur at intervals. Moreover, as suggested above, raw sensor data, acquired as a result of regular polling of sensors by CPU 101, or acquired by dedicated queries (i.e. system triggered polling) scheduled during periods of sensor dormancy, may be aggregated and combined to facilitate perception of elements of the current environment of mobile device 100 in a manner that provides mobile device 100 with a comprehension of the perceived environment, referred to herein as ‘situational awareness’.

Mobile device 100 as disclosed herein implements a situational awareness system, that acquires information that may facilitate perception of elements of its environment, identifies patterns in the perceived elements to facilitate comprehension by the mobile device of its current situation, and finally, to establish criteria upon which action may be taken in connection with the situation as comprehended. The exemplary aspect of this system may be implemented in software stored in memory 102 for execution on CPU 101, or may be embodied in firmware or in hardware ancillary to CPU 101 such as on an application-specific integrated circuit (ASIC).

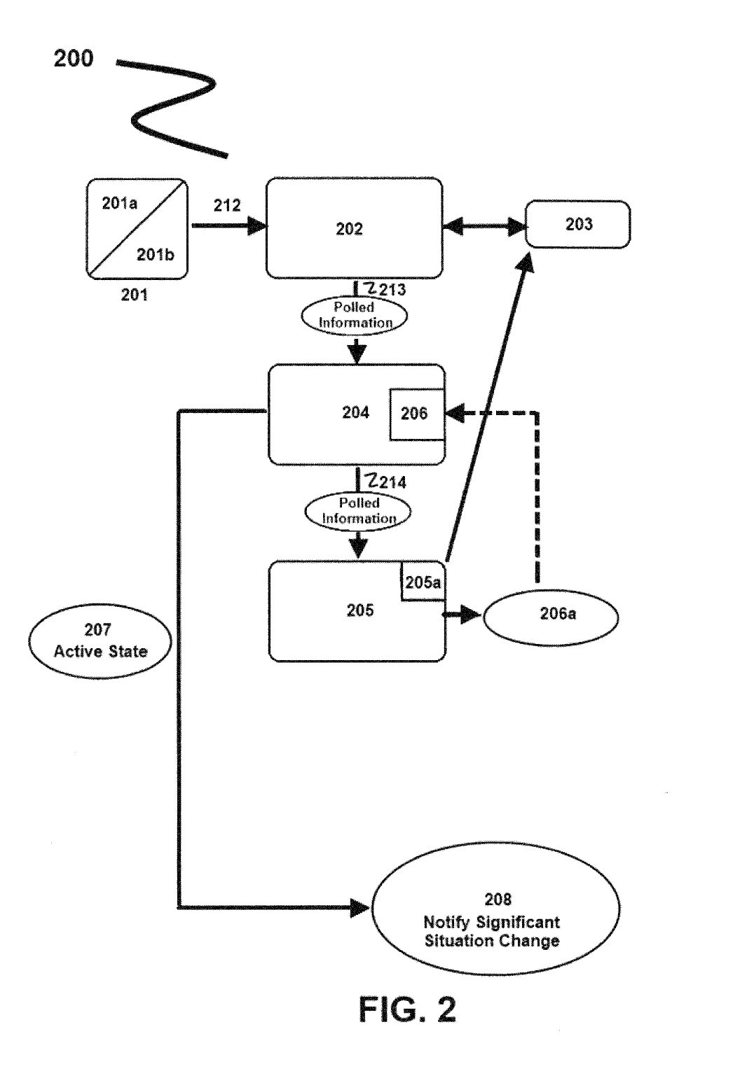

FIG. 2 is a block diagram conceptually illustrating the components of an exemplary aspect of this disclosure of the situational awareness system 200 and the interaction thereof as implemented in a mobile device such as mobile device 100.

Data acquisition module 202 includes memory 203, which may, for example, be a uniquely addressable subset of memory 102 or may be a memory physically separate from memory 102. Depending upon the application, memory 102 may also be remote from mobile device 100, or may reside on removable media, such as a flash drive. Data acquisition module 202 is connected via data transmission/reception channel 212 to one or more sensors in sensor array 201. As understood herein, sensor array 201 represents one or more of any device that can be polled by mobile device 100. More specifically, sensor array 201 may include any one or more sensors or input devices 201a associated with CPU 101, examples of which are discussed in connection with FIG. 1 above. Such devices are also referred to herein as ‘native’ sensors or input devices, as they have a defined function in mobile device 100 independent of the operation of situational awareness system 200. However sensor array 201 may also include input devices 201b which include ‘application-specific’ sensors that do not primarily provide input to mobile device 100, instead being specialized for use in situational awareness system 200.

Data acquisition module 202 is connected to comparator 204 by means of data transmission channel 213. Comparator 204 is connected to pattern-seeking module 205 via data transmission channel 214.

During operation, at least one sensor of sensor array 201 is polled by data acquisition module 202. Polling can take the form of directly accessing the sensor or by accessing the data stream generated during periodic polling conducted by CPU 101 as part of the ordinary operation ordinary operation of mobile device 100. This ‘parasitic’ form of polling by data acquisition module 202 is particularly applicable to sensors 201a, whereas sensors 201b are not generally polled by CPU 101 during the operation of the conventional features of mobile device 100. Moreover, to the extent that data acquisition module 202 requires more frequent, real-time, or detailed information from one or more of sensors 201a, data acquisition module 202 preferably is provided with poll scheduling information to avoid collision with requests expected to be made by CPU 101 during conventional operation and ordinary use of mobile device 100. The polling requirements of data acquisition module 202, both in terms of which sensors are to be polled, and how often, may be set in hardware, or may be internally configurable by software or selectively overridden by the authorized user. The frequency of the polling, if not continuous, need not only be determined by programming located in the data acquisition module 202 or CPU 102, but can be determined elsewhere in mobile device 100. The user may also advantageously specify a higher or lower polling frequency, for example, as needed or in anticipation of different situations. Data can also be polled at different rates for different sensors.

Data acquisition module 202 then stores the raw data from sensor array 201 in memory 203. When necessary, the raw data from the sensors is processed to reflect the situational element being sensed. For example, data from the CCD may require substantial processing, particularly if an image is to undergo facial-recognition. By contrast minimal processing of the signal from a tilt sensor may be necessary to represent the tilt-degree information completely. Optionally, the processed information, referred to herein as polled information, may also be stored in memory 203, to bypass the need to repeatedly process the same raw data.

Mobile device 100 may store the polled information in memory 203 indefinitely. Optionally, mobile device 100 can be programmed to delete information or raw data determined to have become irrelevant.

The polled information is then sent to comparator 204 where it is compared with threshold 206. Threshold 206 may be a range of values between a high value, such as 1 that corresponds to the highest output signal the particular sensor being polled is designed to produce, and a low value of 0, corresponding to the lowest, or no signal. Advantageously, the sensors of sensor array 201 are selected that no environmental condition reasonably expected to occur would result in the maximum signal. Also advantageously, threshold 206 should be set to be triggered only by the highest value by default.

If the information from data acquisition module 202 is found by comparator 204 to have reached or exceeded threshold 206, mobile device 100 is then put into active state 207. The triggering of active state 207 may be accompanied by action 208. If threshold 206 is not exceeded, active state 207 is not triggered, and polled information is passed through to pattern-seeking module 205 without action 208 being triggered. Typically, although not necessarily, the content of polled information from the data acquisition module 202 will be identical to polled information from the comparator 204.

Pattern-seeking module 205 aggregates polled information from each sensor polled by data acquisition module 202 and looks for meaningful patterns in the data. An algorithm for carrying out this process may store multiple records in memory 203 e.g. one record for each sensor, or one record for each characteristic, as well as information obtained by cross-processing the outputs of multiple sensors.

When system 200 is initially activated, for example when the first user of mobile device 100 turns the phone on, no polled information has typically been stored. Accordingly, system 200 would have no baseline by which to evaluate the perceived actions of the authorized user or the relative importance of the environment it has begun to perceive through polling. To the extent that patterns begin to emerge in the polled information that provide meaningful comprehension of the current situation, pattern-seeking module 205 may establish a reference profile 205a, which may be stored for example in memory 203, corresponding to the range of perceived elements most closely associated with the user's ‘normal’ activities in connection with use of mobile device 100. Normal being defined herein as a standard of expected behavior or environmental conditions. Most commonly, normal is established in system 200 through statistical analysis of polled data including real-time analysis of the incoming polled information, although ‘normal’ values may be values provided to system 200 from an external source.

Polling rates are advantageously increased during the initial period after mobile device 100 has been activated for the first time, or with a new user, in order to more quickly populate memory 203 with data to be provided as polled information. Increased data polling, therefore, would be expected to result in a higher resolution reference profile 205a in a given period of operation of system 200. Data polling frequency can also be advantageously increased during times in which the user is likely to engage in routine activities. Mobile device 100 can, for instance, increase polling during a user's commute to work, the commute being expected to provide a rich, data-diverse environment more accurately perceived by frequent polling by multiple sensors.

As values for ‘normal’ are established by pattern-seeking module 205 through communication of sufficient polled information, pattern-seeking module 205 provides an updated threshold 206a, which may be stored by replacing threshold 206 in memory, (which may be memory 203, or as shown, memory local to comparator 204) for access by comparator 204. Threshold 206 may also be understood as a proxy for a range around ‘normal’ as that value is described above.

Advantageously, data from each sensor polled is associated with its own independent threshold. Additional thresholds may exist representing combinations of inputs from groups of more than one sensor or sensor type. This type of cross processing provides a particularly rich source of comprehension, or awareness, of the current situation. Accordingly, there may be more thresholds than sensors, depending on the configuration of the present exemplary aspects of this disclosure.

In the aspect of the disclosure of FIG. 2, in cases where a threshold 206 corresponding to one sensor, or combination of sensors, is set to the highest value (e.g. 1.0) by default, corresponding threshold 206 would be progressively narrowed around a normal value established by analysis of polled information as described above. In the simplest case, a normal value of 0.5 might be represented as a threshold of values between 0.08 and 0.95, wherein polled values outside this range would result in comparator 204 triggering active state 207. After further measurement of that parameter, however, pattern-seeking module 205 might narrow the range further (e.g. 0.2 to 0.6), as its aggregation of information over time increases confidence in the established normal value.

The sum of the information stored in memory 203 over a period of time may be understood as a reference profile of the authorized user or most common user of mobile device 100. The reiterative process described above helps to keep mobile device 100 situationally aware due to the steadily increasing resolution of the reference profile of device 100 as new data is gathered from the array of sensors 201. Alternatively, after a profile has been established, future data added to the reference profile can be limited so that deviations will minimally affect threshold 206 or not at all. Optionally, data added to the reference profile can be limited during certain times so that exceptions will not be included when establishing the reference profile.

The above aspect is illustrated by way of a threshold value having a range around a normal value between 0 and 1. In practice, the reference profile can obtain data on the user's face, fingerprint, battery charging habits, internet usage patterns, etc. Information from sensors such as camera 107 may not be easily reduced to a decimal value. Therefore, advantageously, threshold 206 may be represented by a plurality of discrete complex values, corresponding for example to a voiceprint, image processed through facial-recognition, or complex data related to particular keyboard usage habits. In each case, a mathematical ‘tolerance’ representing a range about the expected voice, face or keystrokes can be established mathematically by methods known in the art.

In accordance with the above, mobile device 100 is alerted to changes in the current situation as a result of perceived deviations from its reference profile as a result of continuous or regular polling of sensor array 201. Mobile device 100 will then either trigger active state 207 as a result of an excursion from the currently valid threshold, or, if there is no excursion, add the information to the record, thus enhancing the robustness of the reference profile, and/or updating threshold 206. In practice, for example, as the depth of data available to pattern-seeking module 205 increases, the system of the current aspect of the embodiment invests greater confidence in the significance of deviations from a reference profile. Most advantageously, confidence can be expressed through a narrowing in the range (or tolerance) around the current normal value. In such cases, the smaller the range, the more likely a small deviation will trigger active state 207. Conversely, in the absence of a reliable reference profile, such as when situational awareness system 200 is first started, a default value of 1 for threshold 206 prevents the triggering of active state 207 at least until pattern-seeking module 205 revises the threshold downward over time. Importantly, however, as the established normal value is expected to change as the number of polling samples increases, the range expressed as threshold 206 may shift, as well as narrow.

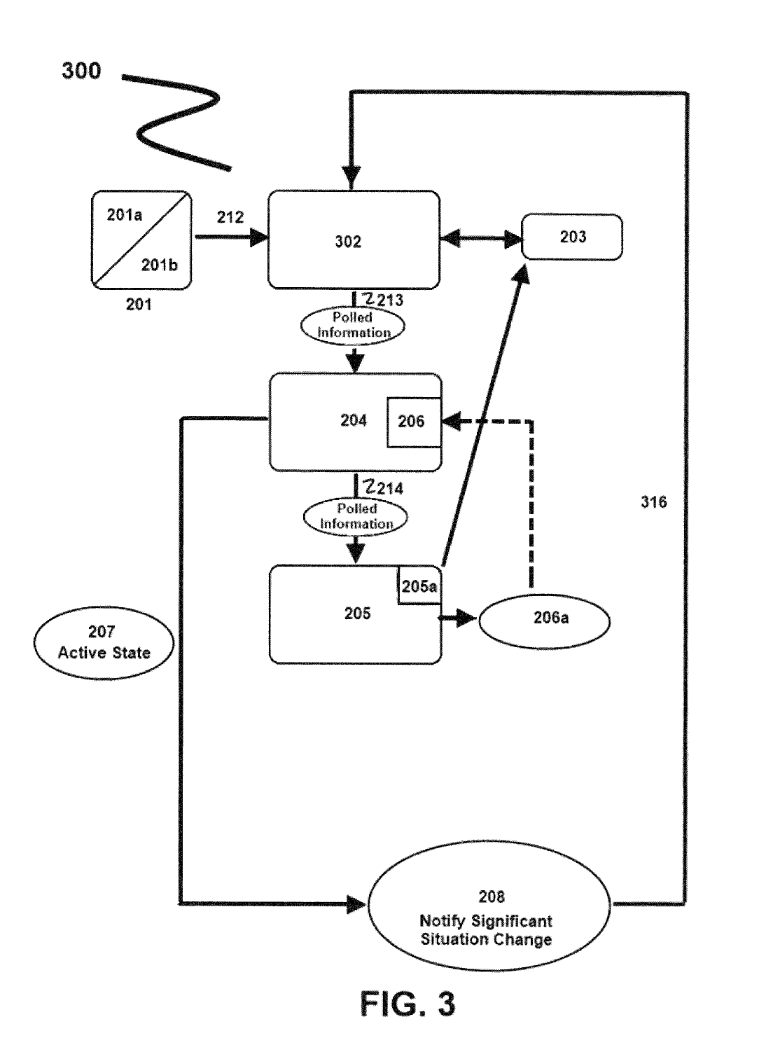

When action 208 is triggered, however, as a result of one of threshold 206 being exceeded, situational awareness system 200 is said to have changed to a second or active state 207. The specific action taken as a result of the change to an active state 207 can vary based on the particular threshold exceeded (a threshold related to changes in Internet use may call for different action from unusual changes in ambient lighting, which may call for different action from the incorrect entry of a password). In addition, as indicated above, different actions may be taken depending on whether the device is lost or stolen. However, according to exemplary aspects of the situational awareness system 200, actions 208 may range from using the phone capability of mobile device 100 to place a notification call, as shown in FIG. 2, to merely changing the way data acquisition module 202 polls sensor array 201 illustrated in FIG. 3.

According to an exemplary aspect of this disclosure, the process can repeat, resulting in a series of nested active states 207, each progressively resulting in a different action taken in response to the most recently comprehended situation. In the aspect of the disclosure of FIG. 3, action 208 in active state 207 is connected with data acquisition module 302 in situational awareness system 300 by feedback connections 316.

In this aspect of the disclosure, data acquisition module 302 additionally manages data acquisition practice. For instance, increasing the number of sensors 201 polled in order to determine more information about the user or surroundings. Additionally, the data acquisition module 302 can poll data continuously or at a faster rate after communication of active state 207 by feedback connection 316. Due to the feedback connection 316, changes may be specific, temporary and/or modified in real-time.

Optionally, after entering active state 207, action 208 can be to communicate to data acquisition module 302 to query sensors 201 to determine if mobile device 100 is lost, with what actions to proceed. Feedback connection 316 can, for example, communicate to data acquisition module 302 to query sensors 201 with the highest likelihood of providing information that can assist in the location of mobile device 100.

As disclosed above, gross alterations to data acquisition practice may be implemented, such as in quickly compiling a reference profile. As disclosed with respect to FIG. 3, such changes may be internally triggered resulting in adaptive changes to polling of polled data, in response to the situational determinations made by situational awareness system 300.

Data acquisition module 302 should be designed to effectively manage the data to be polled and from which sensors 201 the polling is to occur. If mobile device 100 has been lost but not deemed stolen, the polling can for example be focused on RF frequencies to determine whether a communication pathway can be established. By contrast, upon determination that mobile device 100 is stolen, data acquisition module 302 can for example focus on finding information about the user. In an aspect of the disclosure, mobile device 100 can then set another threshold, above which it has sufficient information about the user to communicate to authorities.

Alternatively, after determining that mobile device 100 has been lost or stolen, data acquisition module 302 in active state 207 coordinates native capabilities of the phone with information to be polled. In particular, mobile device 100 factors in the remaining battery life as obtained by the battery voltage sensor 110 in determining future actions. For instance, if mobile device 100 does not sense any radio communication capacity and has a low battery level, a hibernation of mobile device 100 may be ordered. After hibernation, mobile device 100 might advantageously be configured to repoll sensors 201 to determine the RF environment, but would otherwise seek to limit less relevant polling. If the device continues to find no communication pathways, mobile device 100 might again hibernate for a predetermined period of time. Optionally, the second hibernation might be longer than the first hibernation.

In general, however, the objective of such as process would be to enable situation awareness system 300 to survey the resources available, and to martial them in a manner to keep system 300 running as long as possible. Advantageously, therefore, hibernation, as understood herein, includes the shut-down of mobile device features that otherwise would remain active, such as standing by for incoming calls, or background processing not directly related to situational awareness system 300.

Active state 207 described above may be defined as a “nested active state” as the result of the triggering of the active state 207 in this example does not immediately result in any external actions 208 taken by mobile device 100. Indeed, where an active state in this aspect of the disclosure acts, for example, to change the manner of execution of internal processes, situational awareness system 300 advantageously continues to function, and subsequent deviations detected by comparator 204 can trigger additional active states 207. Accordingly, actions 208 may include both internal and external actions.

Referring to FIGS. 2 and 3, the plurality of sensors 201 can be at least any of the component devices described in FIG. 1 which have interaction with the outside world. Situational awareness system 300 relies on the information given by these components. Furthermore, by using capabilities natively found in the plurality of sensors 201, the device does not require the use of additional and possibly more expensive sensors or equipment to function and can usually be implemented with the components currently available on the market to compile a reference profile of the user.

Microphone 104, while used for voice input (i.e. the transmission of spoken words over the phone) from the authorized user or users, can also be used to detect sound. The device can, for example, be used to determine background noise levels and recognize sound combinations, more precisely, sounds such as other phones ringing in the background or the sound of a loud speaker at a train station where the authorized user commutes to work. The voice data mobile device 100 can gather pitch and/or frequency information or can gather a voice print created from parts of conversations taken from the authorized user or users of mobile device 100 while speaking. The voice print can be made for instance during a call or when recording a voice memo. For cameras or other audio/video devices, mobile device 100 could selectively obtain voice samples during use or mobile device 100 can request that the authorized user or users make an initial voice print by means such as using a predetermined phrase read aloud by the authorized user.

The intended meaning of words spoken into the device may be less relevant to the building of a reference profile than other verbal cues in the comprehension of the current situation. Microphone 104 can be programmed to record key phrases (e.g. the word “stolen”) but other metrics including vocal tremors or tone of voice may result in a valid triggering of active state 207 before deviations in other metrics signal comprehension of other details of the situation.

Tilt sensor 105 is a sensor used to orient the screen, normally horizontally or vertically. The device, however, could also use tilt sensor 105 to determine the reference profile polling data regarding the angle of altitude or movement about an axis. Mobile device 100 can use accelerometer 120 to detect if mobile device 100 is, at a given moment, on a subway, traveling in a car or flying in a airplane. This helps to establish more information for use by the pattern-seeking module 205 and can incidentally provide automatic disconnection of wireless components for safety when a user is found to be in an airplane.

Similarly, 3-axis gyroscope 112 can not only be used to determine the location and speed of the authorized user, to play games or to steady images taken by the camera, but can be used to sense if the device is lying on the ground or located elsewhere. In another aspect of the disclosure, 3-axis gyroscope 112 can also sense height measurements to establish the average height of mobile device 100 when in motion or when active (i.e. for a phone, when the authorized user is talking or writing; for a camera, when the picture is being taken; etc.).

Thermometer 106, in addition to protecting the battery by preventing overheating, can be polled by data acquisition module 202 to sense, for example, if device's 100 cover is open or can estimate the temperature of the external environment by extrapolation.

Likewise, camera 107 may have numerous data acquisition capabilities outside its native function as a camera. In an aspect of the disclosure, it may be used to sense faces, take the authorized user's heart rate, sense light levels and capture infrared and radiation levels. Furthermore, the device can use the light sensing capabilities of camera 107 to estimate location (inside or outside) or time of day and/or time zone.

Antenna 108a in conjunction with RF module 108 can be used to sense the authorized user's proximity to a radio or cell tower. Alternatively, because of the wide expanse of the data and voice communication network, lack of any measureable radio signals can itself indicate relevant details about location. Antenna 108a may be used to determine the proximity of mobile device 100 to other devices or, in combination with the CPU 101, the download habits and internet browsing time preferences of the user.

Touchscreen 109 may recognize for example the size of the hand, hand strength, the style of the touch or finger/palm prints. Touchscreen 109 can also use the outline of a finger to determine the tilt of the authorized user's finger's whenever the authorized user is typing. Keypad 109a can record the authorized user's commonly mistyped words, calculate typing speed, and/or determine fingers usually employed for typing. Other types of information disclosed from keypad 109a can be commonly typed word or phrase combinations or incorrect password entry.

Voltage monitor 110 may record characteristic battery recharge behavior and times or the periods of maximum or minimum battery usage.

GPS receiver 111 may show frequent or periodic activities and travel patterns.

Data acquisition module 202/302 can determine from SIM card 113 the authorized user's usual international mobile subscriber identity (IMSI) along with the mobile country code (MCC) and the mobile network code (MNC). Variations to these (i.e. switching out SIM cards) could be a signal of abnormal behavior of the user. Likewise, USB port 114 and Bluetooth can also be monitored to provide information about the user's peripheral devices, e.g. the computer to which the user connects mobile device 100 for power or data transfer. The data stream between USB port 114 and mobile device 100 may also be used to produce at least in part a reference profile of the user's data transferring habits.

A hygrometer can record environmental changes in humidity or the frequency with which the mobile device's 100 cover has been removed. An air pressure sensor (an altimeter or a barometer) could also detect travel details of the user.

In a preferred aspect of the disclosure, data acquisition module 202/302 can poll the authorized user's activity on the device. Data acquisition module 202/302 could store the most common activities of the authorized user in memory 203. Common activities can be entering purchases, using applications, dialing numbers and/or playing games. In a particularly preferred aspect of the disclosure, a common activity could be websites visited by the user.

Mobile device 100 could use the types of or number of applications downloaded to memory 203 in determining threshold 206. For instance, downloading multiple games in a short period, where games were not previously stored on mobile device 100, could be activity beyond threshold 206 and change mobile device 100 into an active state 207.

In active state 207, mobile device 100 may gather information about the user or the situation in which the device is found. In certain aspects of the disclosure, mobile device 100 will assume that the user is not the authorized user. Accordingly, mobile device 100 will attempt to ascertain information about the user without alerting the user of its activity.

In a preferred aspect of the disclosure, mobile device 100 is a wireless device that can be connected to the internet via e.g. 2G/3G/LTE/WiMax, Wi-Fi, etc. In a particularly preferred aspect of the disclosure, mobile device 100 can take action 208 by using audio, video and/or images to determine the user. More particularly, in active state 207 the device can communicate this information to e.g. the authorized user, the authorities, a third party investigative service, etc. by e.g. SMS, e-mail, ftp or similar wireless data transport.

Advantageously, mobile device 100 in an active state 207 can detect fingerprints or similar biometric information. This can be taken off touchscreen 109 when for instance the finger is placed on it to make a movement or by the device asking for the user's particular fingerprint.

Mobile device 100 can optionally capture picture or video from the user by means of camera 109 when a phone call is detected. Mobile device 100 can also take picture or video by means of camera 109 of the surroundings while not in use and forward these images to another device in an effort to communicate to the location or situation. Mobile device 100 may also caption the voice print of the user, or extract or send voice characteristics identifying the user to authorities.

In addition, in active state 207, mobile device 100 can provide the user with incorrect data (“false information”), which can either be remotely downloaded or preprogrammed in the device. The authorized user's private data, i.e. bank account numbers, pin numbers, house number, etc., can be simultaneously erased. The false information can be conveyed to the correct authorities (e.g. the bank) to take appropriate action if the false information is use.

If mobile device 100 is a phone, it can also be programmed in active state 207 to call a ‘notification’ number instead of a number dialed by the user. This ‘notification’ number could be routed to appropriate authorities. If mobile device 100 is a laptop, in active state 207 the laptop could reroute e-mails to or secretly send copies of emails to a ‘notification’ e-mail address. The ‘notification’ email address could be the authorized user's address, a third party's address, the address or the proper authorities, etc. The email could contain the IP address of the computer and other information collected as well as the user's text.

Optionally, mobile device 100 can be brought out of the active state 207 by an authorized user via e.g. sms or e-mail.

In another aspect of the disclosure, mobile device 100 can give false warnings by way of the touchscreen. It can e.g. encourage the user to plug the device into a computer to charge in order to gain access to the information on the computer or get energy to run its clandestine activities.

Mobile device 100 advantageously can contain ‘landmine’ applications (i.e. an application with a secondary function of directly alerting the phone of suspicious behavior without changing the knowledge of the user). Upon engaging the landmine application, the phone could be sent directly into the active state or lower threshold 206.

1. A portable electronic device comprising:
a processing unit having a memory;
a plurality of sensors connected to said processing unit;
a data acquisition module for polling at least one of said sensors and storing related information thereto in memory;
a pattern-seeking module for processing said information to determine a threshold;
a comparator for comparing said information to said threshold;
wherein upon reaching the threshold, the device changes to an active state.

2. The portable electronic device according to claim 1,
wherein the device can connect to a network.

3. The portable electronic device according to claim 1,
wherein decision to undertake activities in active state are based at least in part on the remaining battery power.

4. The portable electronic device according to claim 1,
wherein the threshold is based on the user's prior activity with the device.

5. The portable electronic device according to claim 1,
wherein the threshold can be raised or lowered with another application on the device.

6. The portable electronic device according to claim 2,
wherein at least one of the inputs for the reference profile are websites to which the user usually goes.

7. The portable electronic device according to claim 6,
wherein the threshold is reached when the user is outside any of these common areas.

8. The portable electronic device according to claim 1,
wherein the threshold can be based on common activities of the user with the device.

9. The portable electronic device according to claim 1,
wherein the threshold can be reached if the user fails to do an activity.

10. The portable electronic device according to claim 9,
wherein the activity is an email or sms.

11. The portable electronic device according to claim 1,
wherein the threshold is based at least in part on a fingerprint scan.

12. The portable electronic device according to claim 1,
wherein the threshold is based at least in part on pictures or video of the person using the phone.

13. The portable electronic device according to claim 1,
wherein the threshold is based at least in part on unusual access of web pages.

14. The portable electronic device according to claim 1,
wherein the threshold is based at least in part on voice characteristics of the person using the phone.

15. The portable electronic device according to claim 1,
wherein the threshold is adjustable.

16. The portable electronic device according to claim 1,
wherein the device in active state, records the user.

17. The portable electronic device according to claim 1,
wherein the device in active state, detects fingerprints of the user.

18. The portable electronic device according to claim 17,
wherein the device in active state, transmits the fingerprints.

19. The portable electronic device according to claim 1,
wherein the device in active state, detects fingerprints of the user.

20. The portable electronic device according to claim 2,
wherein in active state the device calls a different number from the number dialed by the user.

21. The portable electronic device according to claim 20,
wherein the number dialed is a security service.

22. The portable electronic device according to claim 1,
wherein in active state the phone deletes the authorized user's private information and inserts fake private information.

23. The portable electronic device according to claim 1,
wherein the sensors are also used to determine if the device is in a moving vehicle.

24. The portable electronic device according to claim 23,
wherein upon detection from one of the sensors that the device is in an airplane, the device shuts off.

25. The portable electronic device according to claim 1,
wherein the sensors are also used to determine the height of the user.

26. The portable electronic device according to claim 3,
wherein the device sends all information in the memory to a predetermined location upon reaching a predetermined level of battery power.

27. A method for determining if a portable electronic device is lost or stolen comprising:
polling information from at least one of a plurality of sensors,
storing said information in a memory;
processing said information to determine a threshold;
comparing said information to said threshold;
wherein upon reaching the threshold, the device changes to an active state.

28. A non-transitory computer-readable media for carrying out a method for determining if a portable electronic device is lost or stolen, the method comprising:
polling information from at least one of a plurality of sensors,
storing said information in a memory;
processing said information to determine a threshold;
comparing said information to said threshold;
wherein upon reaching the threshold, the device changes to an active state.
